(19) United States
(12) Patent Application Publication
(10) Pub. No.: US 2005/0136298 A1
(43) Pub. Date: Jun. 23, 2005

(54) Methods of treating fuel cells and fuel cell systems

(76) Inventors: Manikandan Ramani, Watervliet, NY (US); David J. Bodner, Waterford, NY (US); Matthew W. Miller, Loudonville, NY (US); Marie A. Schnitzer, Latham, NY (US); Richard N. Miklas, Ganesvoort, NY (US)

Correspondence Address: FISH & RICHARDSON PC, 225 FRANKLIN ST, BOSTON, MA, 02110, US

(21) Appl. No.: 10/741,223

(22) Filed: Dec. 19, 2003

(51) Int. Cl. H01M 8/04; H01M 8/00

(52) U.S. Cl. 429/17; 429/13

(57) ABSTRACT

In one aspect, the invention features a method including contacting a first gas to an anode of a fuel cell, and contacting a second gas to a cathode of the fuel cell. The first gas is capable of interacting with the anode to form protons, and the second gas is substantially free of a gas capable of being reduced by the cathode.

### TECHNICAL FIELD

The invention relates to methods of treating fuel cells and fuel cell systems.

### BACKGROUND

A fuel cell can convert chemical energy to electrical energy by promoting electrochemical reactions between two reactants.

One type of fuel cell includes a cathode flow field plate, an anode flow field plate, a membrane electrode assembly disposed between the cathode flow field plate and the anode flow field plate, and two gas diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each flow field plate has an inlet region, an outlet region and open-faced channels connecting the inlet region to the outlet region and providing a way for distributing the gases to the membrane electrode assembly.

The membrane electrode assembly usually includes a solid electrolyte (e.g., a proton exchange membrane, commonly abbreviated as a PEM) between a first catalyst and a second catalyst. One gas diffusion layer is between the first catalyst and the anode flow field plate, and the other gas diffusion layer is between the second catalyst and the cathode flow field plate.

During operation of the fuel cell, one of the gases (the anode gas) enters the anode flow field plate at the inlet region of the anode flow field plate and flows through the channels of the anode flow field plate toward the outlet region of the anode flow field plate. The other gas (the cathode gas) enters the cathode flow field plate at the inlet region of the cathode flow field plate and flows through the channels of the cathode flow field plate toward the cathode flow field plate outlet region.

As the anode gas flows through the channels of the anode flow field plate, the anode gas diffuses through the anode gas diffusion layer and interacts with the anode catalyst. Similarly, as the cathode gas flows through the channels of the cathode flow field plate, the cathode gas diffuses through the cathode gas diffusion layer and interacts with the cathode catalyst.

The anode catalyst interacts with the anode gas to catalyze the conversion of the anode gas to reaction intermediates. The reaction intermediates include ions and electrons. The cathode catalyst interacts with the cathode gas and the anode reaction intermediates to catalyze the conversion of the cathode gas to the chemical product of the fuel cell reaction.

The chemical product of the fuel cell reaction flows through a gas diffusion layer to the channels of a flow field plate (e.g., the cathode flow field plate). The chemical product then flows along the channels of the flow field plate toward the outlet region of the flow field plate.

The electrolyte provides a barrier to the flow of the electrons and gases from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load, to the cathode flow field plate, and to the cathode side of the membrane electrode assembly.

Electrons are formed at the anode side of the membrane electrode assembly, indicating that the anode gas undergoes oxidation during the fuel cell reaction. Electrons are consumed at the cathode side of the membrane electrode assembly, indicating that the cathode gas undergoes reduction during the fuel cell reaction.

For example, when hydrogen and oxygen are the gases used in a fuel cell, hydrogen flows through the anode flow field plate and undergoes oxidation. Oxygen flows through the cathode flow field plate and undergoes reduction. The specific reactions that occur in the fuel cell are represented in equations 1-3.
H₂→2H⁺+2e⁻ (1)
½O₂+2H⁺+2e⁻→H₂O (2)
H₂+½O₂→H₂O (3)

As shown in equation 1, hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

The invention relates to methods of treating fuel cells and fuel cell systems.

Prior to operating a fuel cell or a fuel cell system under its normal operating conditions, the cell or system sometimes undergoes an incubation or conditioning period. Conditioning the fuel cell or system can hydrate the solid electrolyte and clean (e.g., lower the charge transfer resistance of) catalyst materials in the electrodes. As a result, the operating performance of the cell or the system can be enhanced, for example, relative to the performance of a substantially identical cell or system that has not been incubated or conditioned. The invention features methods that can be used to incubate or to condition a fuel cell or a fuel cell system, thereby enhancing the performance of the cell or system. The methods feature relatively short (e.g., less than about 75 minutes) process times (e.g., relative to other condition processes that can take more than three hours). Shortening the conditioning period can increase efficiency and reduce cost. The methods also offer a relatively simple set-up.

In one aspect, the invention features a method including contacting a first gas to an anode of a fuel cell, the first gas capable of interacting with the anode to form protons; and contacting a second gas to a cathode of the fuel cell, the second gas being substantially free of a gas capable of being reduced by the cathode.

Embodiments may include one or more of the following features. The first gas and the second gas contain hydrogen gas. The first gas is contacted to the anode simultaneously with contacting the second gas to the cathode. The first gas further contains water. The first gas is a reformate gas. The second gas further contains water. The second gas is contacted to the cathode at a higher pressure than the first gas is contacted to the anode. The cathode is negative relative to the anode. The fuel cell is a part of a fuel cell stack.

In addition, the method can include one or more of the following features. The method includes intermittently contacting the first gas to the anode and intermittently contacting the second gas to the cathode. The method further includes operating the fuel cell to provide electrical power during an intermission of contacting the first and second gases to the anode and the cathode, respectively. The method further includes applying a potential between the anode and the cathode. The method further includes monitoring the potential difference between the cathode and the anode. The method further includes, after contacting the second gas to the cathode, contacting oxygen gas to the cathode, the fuel cell providing electrical power. The method includes passing the second gas through an anode outlet.

In another aspect, the invention features a method of treating a fuel cell, including contacting a first gas containing hydrogen gas and water to an anode of the fuel cell; simultaneously with contacting the first gas, contacting a second gas containing hydrogen gas and water to a cathode of the fuel cell, wherein the second gas is contacted to the cathode at a higher pressure than the first gas is contacted to the anode; and applying a potential difference between the anode and the cathode, the cathode being negative relative to the anode.

In another aspect, the invention features a method including contacting a first gas containing hydrogen gas to an anode of a fuel cell; and contacting a second gas to a cathode of the fuel cell. The second gas is substantially free of a gas capable of being reduced by the cathode.

Embodiments may include one or more of the following features. The first gas is contacted to the anode simultaneously with contacting the second gas to the cathode. The first gas further contains water. The first gas is a reformate gas. The second gas further contains water. The second gas consists essentially of nitrogen gas. The second gas is contacted to the cathode at a higher pressure than the first gas is contacted to the anode. The fuel cell is a part of a fuel cell stack. The fuel cell has a polymer electrolyte membrane. The cathode is negative relative to the anode.

In addition, the method can include one or more of the following features. The method includes intermittently contacting the first gas to the anode and intermittently contacting the second gas to the cathode. The method further includes operating the fuel cell to provide electrical power during an intermission of contacting the first and second gases to the anode and the cathode, respectively. The method further includes applying a potential between the anode and the cathode. The method further includes monitoring the potential difference between the cathode and the anode. The method further includes, after contacting the second gas to the cathode, contacting oxygen gas to the cathode, the fuel cell providing electrical power. The method further includes passing the second gas through an anode outlet.

In another aspect, the invention features a method of treating a fuel cell, including contacting a first gas containing hydrogen gas and water to an anode of the fuel cell; simultaneously with contacting the first gas, contacting a second gas containing nitrogen gas and water to a cathode of the fuel cell, wherein the second gas is contacted to the cathode at a higher pressure than the first gas is contacted to the anode; and applying a potential difference between the anode and the cathode, the cathode being negative relative to the anode.

Other aspects, features and advantages of the invention will be apparent from the description of the preferred embodiments thereof and from the claims.

### DESCRIPTION OF DRAWINGS

FIG. 1 is a schematic diagram of an embodiment of a fuel cell system.

FIG. 2 is a partial cross-sectional view of an embodiment of a fuel cell.

FIG. 3 is a plot of voltage versus time.

FIG. 4 is an elevational view of an embodiment of a cathode flow field plate.

FIG. 5 is an elevational view of an embodiment of an anode flow field plate.

FIG. 6 is an elevational view of an embodiment of a coolant flow field plate.

FIG. 7 is a table of results from a number of conditioning experiments.

### DETAILED DESCRIPTION

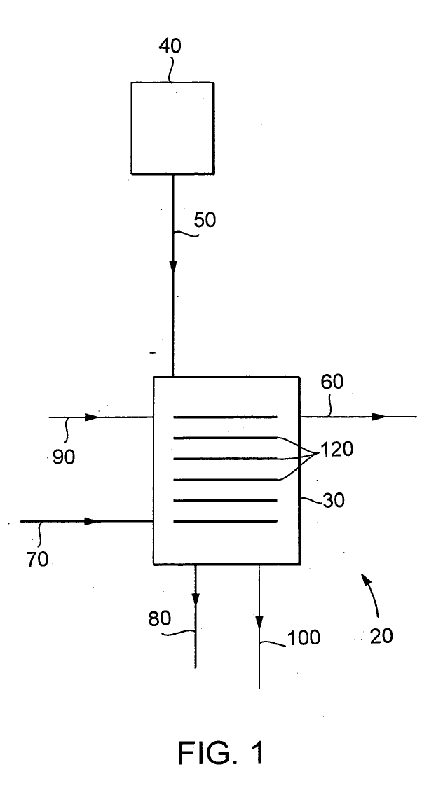

FIG. 1 shows a fuel cell system 20 having a fuel cell stack 30 that includes a plurality of fuel cells 120. Fuel cell system 20 further includes an anode gas supply 40, an anode gas inlet line 50, an anode gas outlet line 60, a cathode gas inlet line 70, a cathode gas outlet line 80, a coolant inlet line 90, and a coolant outlet line 100. An example of a fuel cell system is the GenCore™ system (available from PlugPower, Latham, N.Y.).

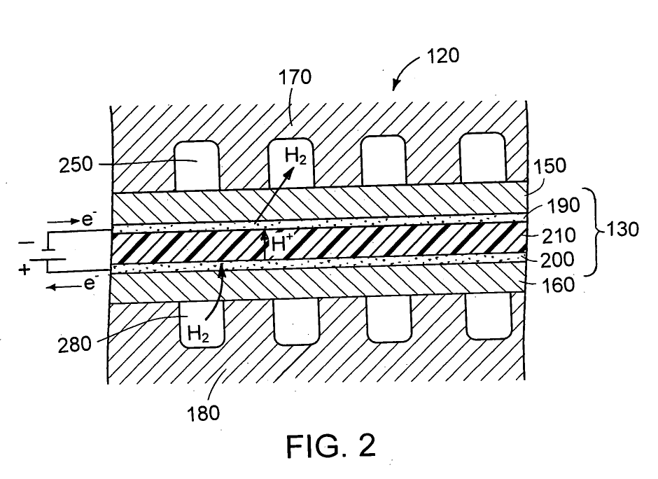

Referring to FIG. 2, an embodiment of fuel cell 120 is shown having a membrane electrode assembly 130, gas diffusion layers (GDLs) 150 and 160, a cathode flow field plate 170, and an anode flow field plate 180. Membrane electrode assembly (MEA) 130 includes two electrodes (a cathode 190 and an anode 200), and a solid electrolyte 210 between the electrodes. Cathode 190 and anode 200 can include, for example, a catalyst (such as platinum) and an ion conductive material (such as an ionomeric material). Cathode flow field plate 170 has cathode gas channels 250, and anode flow field plate 180 has channels 280.

Prior to operating fuel cells 120 under selected normal operating conditions to yield electrical power, the fuel cells are conditioned or incubated to enhance their operating performance. Fuel cells 120 can be conditioned by introducing to anode 200 a gas (e.g., hydrogen gas fuel) capable of interacting with the anode to form protons and electrons, while introducing a second gas to cathode 190. Concurrently, a potential difference is applied between the anode and cathode 190. As shown in FIG. 2, cathode 190 is negative relative to anode 200, e.g., less than a few volts for a stack having 88 fuel cells.

The conditioning process described above produces a process sometimes called “fuel pumping” or “hydrogen pumping”. More specifically, as a result of the potential difference, the formed electrons travel from anode 200, through an external load, and to cathode 190; and the formed protons travel from the anode, through solid electrolyte 210, and to the cathode. At cathode 190, the protons and the electrons recombine to form hydrogen gas. Thus, hydrogen has been delivered to a first electrode (the anode), “pumped” to a second electrode (the cathode), and emitted from the second electrode. Without wishing to be bound by theory, it is believed that hydrogen pumping enhances performance of fuel cells 120 by reducing certain material(s) (such as platinum oxides or platinum hydroxides) in cathode 190, thereby cleaning or activating the cathode to expose fresh catalyst material. Formation of hydrogen gas, e.g., in the form of microscopic hydrogen bubbles, may also create and/or open up pores in the catalyst material, thereby increasing the accessibility of reactant gases to the catalyst material. In addition, the hydrogen produced on cathode 190 can provide a reducing environment that can reduce the amount of organic contaminants on the surface of the cathode. In some embodiments, the hydrogen gas is delivered in the form of pure hydrogen gas, a substantially pure hydrogen gas mixture (e.g., >95% H₂ with one or more other gases, such as nitrogen), or a reformate gas (i.e., a gas containing H₂ delivered from a reformer).

What is more, as indicated above, while hydrogen gas is introduced to anode 200, a second gas is introduced to cathode 190. The second gas can be, for example, hydrogen gas and/or an inert gas, such as nitrogen or argon. The second gas is preferably substantially free (e.g., less than about 5%, about 4%, about 3%, about 2%, or about 1%) of a material (such as oxygen) capable of interacting with (e.g., being oxidized or reduced by) cathode 190. It is believed that introduction of the second gas forms a diffusion gradient or front that assists in removing hydrogen that has been pumped to cathode 190. Furthermore, in embodiments in which the second gas includes hydrogen gas, the second gas can further enhance cleaning and activation of cathode 190. It is believed, for example, that hydrogen gas pumped from anode 200 cleans cathode 190 electrochemically, and that hydrogen gas introduced directly to the cathode cleans the cathode chemically. That is, the hydrogen gas in the second gas can chemically react with (e.g., reduce) oxides and/or hydroxides in cathode 190 to activate the cathode. In some embodiments, the second gas includes a mixture of gases, e.g., a reformate gas or H₂/N₂. During conditioning, one or both gases can be vented through anode gas outlet line 60, for example, to be recycled back to anode 200.

In preferred embodiments, the gases introduced to cathode 190 and anode 200 are humidified, i.e., contain water vapor. The water vapor helps to hydrate solid electrolyte 210 and the ionomers in the electrodes, which can lose water during conditioning. In some cases, the gases introduced to cathode 190 and anode 200 have a 100% relative humidity.

In preferred embodiments, one or both gases are introduced at elevated pressures. For example, the gas introduced to anode 200 can be at ambient pressure, while the second gas can be introduced at a higher pressure (e.g., from about one to about ten psig, e.g., from about two to about five psig) to cathode 190. It is believed that delivering the second gas humidified and at an elevated pressure can replenish water in solid electrolyte 210 and the ionomer in anode 200, both of which can lose water during conditioning. In some cases, the pressure of gas introduced to anode 200 is higher than the pressure of the second gas introduced to cathode 190. Under some circumstances, higher pumping currents can benefit from introducing the second gas at higher pressures.

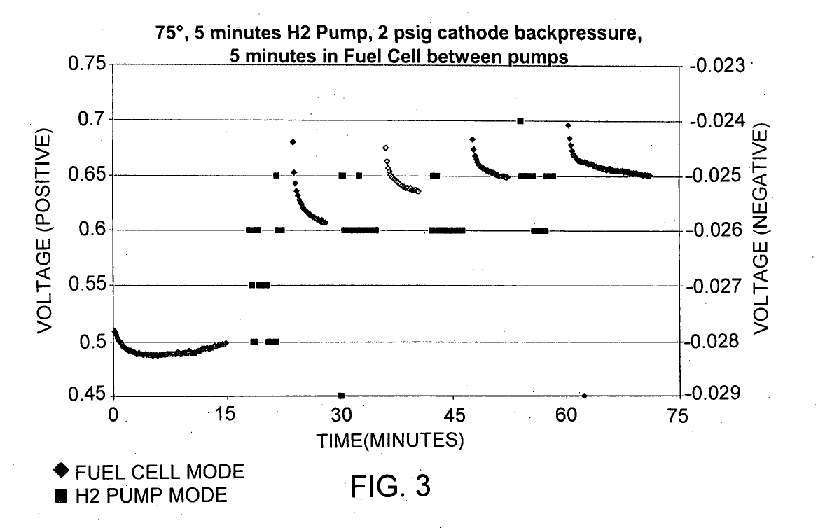

During conditioning, the progress of conditioning can be monitored to provide an indication of when conditioning is complete. FIG. 3 shows plots of voltages versus time during a conditioning period that included four hydrogen pump periods interrupted by periods during which the fuel cell stack was operated under normal operating conditions (“fuel cell mode”). As shown, the fuel cell stack was operated under fuel cell mode for fifteen minutes, followed by a first hydrogen pump period at 52 A with the cathode under a backpressure of two psig for five minutes. After the first hydrogen pumping period, the fuel cell stack was operated under fuel cell mode for five minutes. During fuel cell mode, the cell voltage is high initially because the water concentration closer to the catalyst layer is low after fuel pumping. The water concentration then rapidly reaches a steady state value on the cathode and imposes a diffusion resistance to the air, which it is believed, indicated by the rapid decline of the voltage to a pseudo-steady state value. Next, additional cycles of hydrogen pumping and fuel cell mode are performed (as shown, three more times). Conditioning is considered complete when, in fuel cell mode, the cell voltage decreases to substantially the same value (as shown, about 0.65 Volt).

Turning back to the structure of fuel cell 120 shown in FIG. 2, electrolyte 210 should be capable of allowing ions to flow therethrough while providing a substantial resistance to the flow of electrons. In some embodiments, electrolyte 210 is a solid polymer (e.g., a solid polymer ion exchange membrane), such as a solid polymer proton exchange membrane (e.g., a solid polymer containing sulfonic acid groups). Such membranes are commercially available from E.I. DuPont de Nemours Company (Wilmington, Del.) under the trademark NAFION. Alternatively, electrolyte 210 can also be prepared from the commercial product GORE-SELECT, available from W.L. Gore & Associates (Elkton, Md.).

Anode 200 can be formed of a material capable of interacting with hydrogen to form protons and electrons. Examples of anode catalyst materials include, for example, platinum, platinum alloys, platinum dispersed on carbon black, and non-noble metal materials. Anode 200 can further include an electrolyte, such as an ionomeric material (e.g., NAFION) to enhance proton conduction. In some embodiments, a suspension of catalyst material and electrolyte is applied to the surfaces of gas diffusion layers (described below) that face solid electrolyte 210, and the suspension is then dried. During the preparation of MEA 130, catalyst material (e.g., platinum) can be applied to electrolyte 210 using standard techniques. The method of preparing anode 200 may further include the use of pressure and temperature (e.g., hot bonding) to achieve bonding.

Cathode 190 can be formed of a material capable of interacting with oxygen, electrons and protons to form water. Examples of cathode catalyst materials include, for example, platinum, platinum alloys, noble metals dispersed on carbon black, and non-noble metal materials. Cathode 190 can further include an electrolyte, such as an ionomeric material (e.g., NAFION) to enhance proton conduction. Catalyst layer 190 can be prepared as described above with respect to anode 200.

Gas diffusion layers (GDLS) 150 and 160 are electrically conductive so that electrons can flow from anode 200 to flow field plate 180 and from flow field plate 170 to cathode 190. GDLs can be formed of a material that is both gas and liquid permeable. It may also be desirable to provide the GDLs with a planarizing layer, as is known in the art, for example, by infusing a porous carbon cloth or paper with a slurry of carbon black followed by sintering with a polytetrafluoroethylene material. Suitable GDLs are available from various companies such as E-TEK, a division of De Nora (e.g., ELAT®) in Somerset, N.J., and Zoltek in St. Louis, Mo.

Methods of making membrane electrode assemblies and membrane electrode units are known, and are described, for example, in U.S. Pat. No. 5,211,984, which is hereby incorporated by reference.

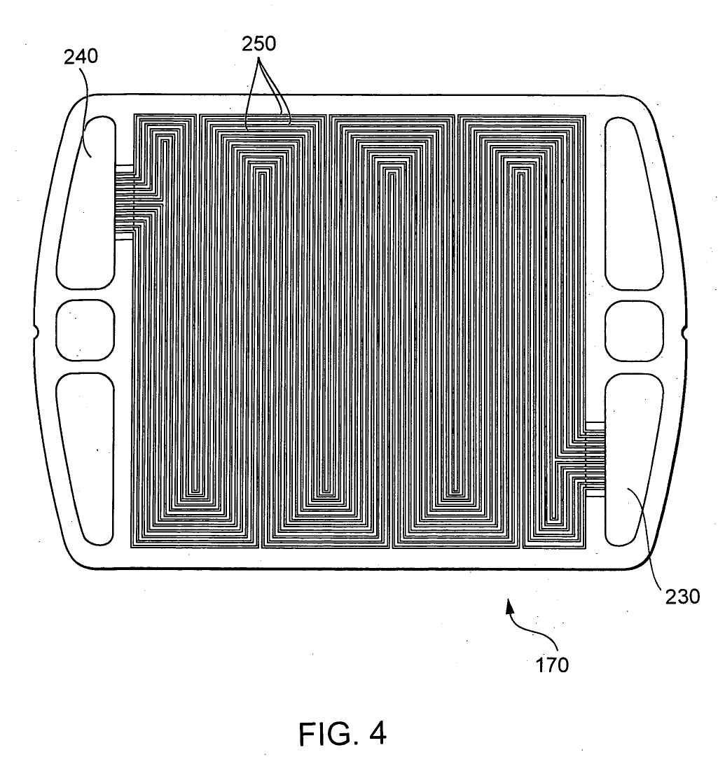

FIG. 4 shows a cathode flow field plate 170 having an inlet 230, an outlet 240, and open-faced channels 250 that define a flow path for a cathode gas from inlet 230 to outlet 240. A cathode gas flows from cathode gas inlet line 70 and enters flow field plate 170 via inlet 230 to cathode outlet line 80. The cathode gas then flows along channels 250 and exits flow field plate 170 via outlet 240. As the cathode gas flows along channels 250, oxygen contained in the cathode gas can permeate gas diffusion layer 150 and interact with catalyst layer 190. Electrons and protons present at layer 150 react with the oxygen to form water. The water can pass back through diffusion layer 150, enter the cathode gas stream in channels 250, and exit plate 170 through cathode flow field plate outlet 240.

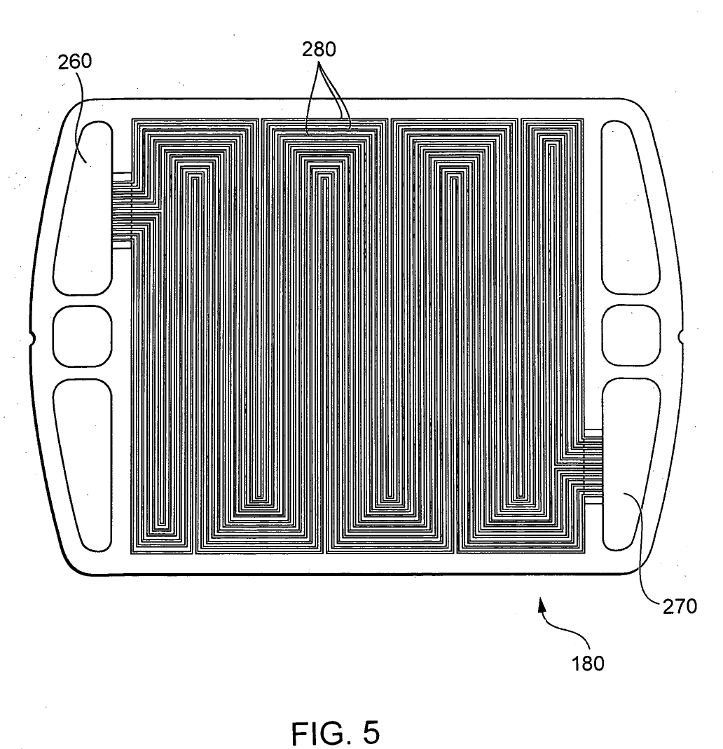

FIG. 5 shows an anode flow field plate 180 having an inlet 260, an outlet 270, and open-faced channels 280 that define a flow path for an anode gas from inlet 260 to outlet 270. An anode gas flows from the anode gas inlet line 50 and enters flow field plate 180 via inlet 260. The anode gas then flows along channels 280 and exits flow field plate 180 via outlet 270 to anode outlet line 60. As the anode gas flows along channels 280, hydrogen contained in the anode gas can permeate gas diffusion layer 160 and interact with catalyst layer 200 to form protons and electrons. The protons pass through solid electrolyte 210, and the electrons are conducted through gas diffusion layer 160 to anode flow field plate 180, ultimately flowing through an external load to cathode flow field plate 170.

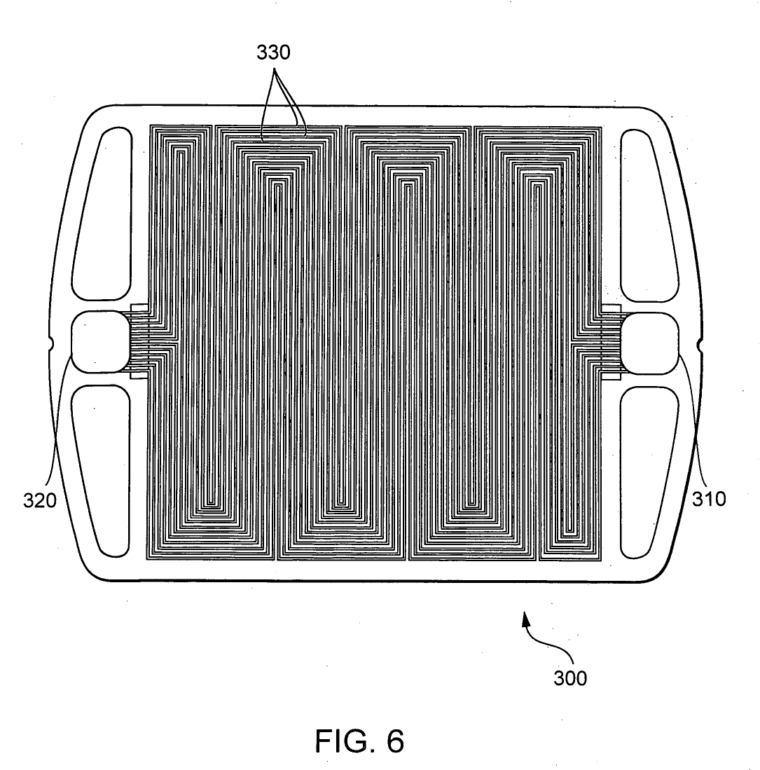

Heat produced during the fuel cell reaction is removed from fuel cell 120 by flowing a coolant through fuel cell 120 via a coolant flow field plate. FIG. 6 shows a coolant flow field plate 300 having an inlet 310, an outlet 320 and open-faced channels 330 that define a flow path for coolant from inlet 310 to outlet 320. The coolant enters fuel cell 120 from coolant inlet line 90 via inlet 310, flows along channels 330 and absorbs heat, and exits fuel cell 120 via outlet 320 to coolant outlet line 100.

Fuel cells 120 are arranged within fuel cell stack 30 such that inlets 260 are configured to be in fluid communication with anode gas inlet line 50, and outlets 270 are configured to be in fluid communication with anode gas outlet line 60. Similarly, inlets 230 are configured to be in fluid communication with cathode gas inlet line 70, and outlets 240 are configured to be in fluid communication with cathode gas outlet line 80. Likewise, inlets 310 are configured to be in fluid communication with coolant inlet line 90, and outlets 320 are configured to be in fluid communication with coolant gas outlet line 100.

While certain embodiments have been described, other embodiments are contemplated. For example, fuel (e.g., hydrogen, reformate gas, or H₂/N₂) can be pumped from the cathode to anode, e.g., by setting the potential of the anode negative relative to the potential of the cathode. The second gas, e.g., including H₂, N₂, Ar, or H₂/N₂, can be introduced to the anode as described above for the cathode.

Fuel other than hydrogen, e.g., methane or propane, can be introduced to a fuel cell system and the fuel cells. The methods described herein can be applied to any fuel cells having catalyst materials, such as direct methanol fuel cells (DMFCs), which are described, for example, in U.S. Pat. Nos. 4,478,917; 5,599,638; and 6,248,460 B1.

The conditioning methods described herein can be used in combination with other conditioning methods. An example of another conditioning method is described in U.S. Ser. No. 10/072,592, filed Feb. 11, 2002, which includes operating fuel cell(s) above ambient conditions (e.g., elevated temperatures and pressures) prior to operating the cell(s) under normal operating conditions. Another example of a condition method is described in commonly assigned U.S. Ser. No. ______, filed Dec. 17, 2003 [Attorney Docket No. 10964-062001], which includes sorbing and desorbing, for example, carbon monoxide, at one or more electrode being conditioned. Both applications are hereby incorporated by reference in their entirety.

The conditioning methods described herein, alone or in combination with other conditioning methods, can be used at any time during the life of a fuel cell or a fuel cell system. For example, the method(s) can be used to re-activate the catalyst layer(s) as part of a maintenance regimen or routine.

The following example is illustrative and not intended to be limiting.

### EXAMPLE

Commercial GORE-SELECT 55 SERIES membrane electrode assemblies (MEAs) were assembled into a stack with graphite composite bipolar plates. As many as 88 cells were stacked together in between bipolar collector plates. Each MEA carried an active area of 262 cm² on catalyst coated membrane and a Toray-like GDL was laminated on both anode and cathode side of the electrodes. The bipolar collector plates sandwiched the MEAs with a clamping force of close to 5000 lbs. During all fuel cell mode testing, the reactant stoichiometries were 1.5 for hydrogen and 2.5 for the air. Pure hydrogen was used in fuel cell mode and pumping mode.

One example of an incubation process included flowing hydrogen and air to the anode and to the cathode, respectively, for approximately ten minutes to heat up the stack along with the coolant, typically to 40-45° C. An initial load of 0.1 A/cm² current density was applied for approximately ten minutes until the stack heated up to 70° C. Flows were increased to allow a demand of 1 Amp/cm² current density. The load was applied until a minimum cell voltage of 0.4 V was achieved. This load was held constant for fifteen minutes. The gases were kept flowing, and the load was turned to 0 Amps. After 1 minute, the load was re-applied and adjusted until a minimum cell voltage of 0.4 V was achieved. The incubation was considered complete when a current demand of 1.05 A/cm² was met with the same minimum cell voltage requirements. This incubation process example takes about three to four hours to complete.

The incubation or conditioning process described above can be completed in about 0.75-1.5 hour. The condition process included flowing hydrogen and air to the electrodes for approximately ten minutes to heat up the stack along with the coolant, typically to about 40-45° C. An initial load of 0.1 A/cm² current density was applied for approximately ten minutes until the stack heated up to 70° C. Gas flows were increased to allow a demand of 1 Amps/cm² current density. This was immediately followed by increasing the current density to 0.7 Amps/cm² in steps of 0.1 A/cm². The stack was allowed to operate at a constant current density for fifteen minutes (fuel cell mode).

Next, the gas flows were turned off and both inlets were purged with nitrogen for two minutes. During the nitrogen purge, a load of 1 Amp was applied to assist bleeding the voltage to 0.05 V/per cell. The anode and cathode stack exhausts were plumbed to the anode exhaust.

Next, hydrogen was flowed at 200 slm to the anode side, and a 5 V DC power supply was placed in series with the stack and a load bank (Dynaload). A load of 0.2 A/cm² was applied in increments of 5 Amps. A two-psig cathode backpressure was created by manually adjusting a regulator close to the exhaust manifold. These operating conditions were continued for five minutes, and the gas flows and load were subsequently turned off. Both inlets were then purged with nitrogen for two minutes.

The power supplied was then turned and the stack configuration was returned to fuel cell mode. Gas flows corresponding to 0.7 A/cm² was turned on, and a load of 0.7 A/cm² was applied in quick increments. The stack was operated in fuel cell mode for about five minutes. Four of the cycles described above were repeated. At the end of first cycle, an incubation criterion was satisfied at 0.6 V at 0.7 Amps/cm² in about 35 minutes plus ten minutes of flowing gas. Prolonged cycling can result in as much as 50 mV more than the incubation criterion.

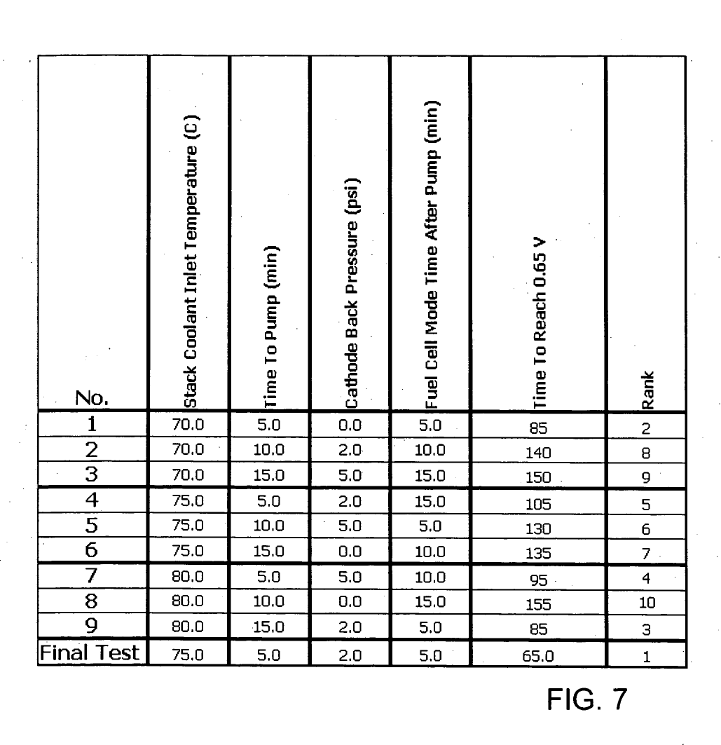

Different backpressures were also studied. It is believed that a backpressure of 2 psig is the optimum condition for 0.2 A/cm², and that higher backpressure may be needed at higher current densities. A summary table of responses from different experiments is shown in FIG. 7. The variable parameters were temperature, time at load during fuel cell mode, time at load during pumping mode, and cathode backpressure during pumping mode. The time to achieve 0.65 V (mean cell voltage) was determined.

All references, including patents, applications, and publications, referred to herein are incorporated by reference in their entirety.

Other embodiments are within the claims.

1. A method, comprising:
contacting a first gas to an anode of a fuel cell, the first gas capable of interacting with the anode to form protons; and
contacting a second gas to a cathode of the fuel cell, the second gas being substantially free of a gas capable of being reduced by the cathode.

2. The method of claim 1, wherein the first gas and the second gas comprise hydrogen gas.

3. The method of claim 1, wherein the first gas is contacted to the anode simultaneously with contacting the second gas to the cathode.

4. The method of claim 3, comprising intermittently contacting the first gas to the anode and intermittently contacting the second gas to the cathode.

5. The method of claim 4, further comprising operating the fuel cell to provide electrical power during an intermission of contacting the first and second gases to the anode and the cathode, respectively.

6. The method of claim 1, further comprising applying a potential between the anode and the cathode.

7. The method of claim 6, wherein the cathode is negative relative to the anode.

8. The method of claim 1, further comprising monitoring the potential difference between the cathode and the anode.

9. The method of claim 1, wherein the second gas is contacted to the cathode at a higher pressure than the first gas is contacted to the anode.

10. The method of claim 1, further comprising, after contacting the second gas to the cathode, contacting oxygen gas to the cathode, the fuel cell providing electrical power.

11. The method of claim 1, wherein the first gas further comprises water.

12. The method of claim 1, wherein the second gas further comprises water.

13. The method of claim 1, further comprising passing the second gas through an anode outlet.

14. The method of claim 1, wherein the fuel cell is a part of a fuel cell stack.

15. The method of claim 1, wherein the first gas is a reformate gas.

16. A method of treating a fuel cell, comprising:
contacting a first gas comprising hydrogen gas and water to an anode of the fuel cell;
simultaneously with contacting the first gas, contacting a second gas comprising hydrogen gas and water to a cathode of the fuel cell, wherein the second gas is contacted to the cathode at a higher pressure than the first gas is contacted to the anode; and
applying a potential difference between the anode and the cathode, the cathode being negative relative to the anode.

17. A method, comprising:
contacting a first gas comprising hydrogen gas to an anode of a fuel cell; and
contacting a second gas to a cathode of the fuel cell, the second gas being substantially free of a gas capable of being reduced by the cathode.

18. The method of claim 17, wherein the second gas consists essentially of nitrogen gas.

19. The method of claim 17, wherein the first gas is contacted to the anode simultaneously with contacting the second gas to the cathode.

20. The method of claim 17, comprising intermittently contacting the first gas to the anode and intermittently contacting the second gas to the cathode.

21. The method of claim 20 further comprising operating the fuel cell to provide electrical power during an intermission of contacting the first and second gases to the anode and the cathode, respectively.

22. The method of claim 17, further comprising applying a potential between the anode and the cathode.

23. The method of claim 22, wherein the cathode is negative relative to the anode.

24. The method of claim 17, further comprising monitoring the potential difference between the cathode and the anode.

25. The method of claim 17, wherein the second gas is contacted to the cathode at a higher pressure than the first gas is contacted to the anode.

26. The method of claim 17, further comprising, after contacting the second gas to the cathode, contacting oxygen gas to the cathode, the fuel cell providing electrical power.

27. The method of claim 17, wherein the first gas further comprises water.

28. The method of claim 17, wherein the second gas further comprises water.

29. The method of claim 17, further comprising passing the second gas through an anode outlet.

30. The method of claim 17, wherein the fuel cell is a part of a fuel cell stack.

31. The method of claim 17, wherein the first gas is a reformate gas.

32. The method of claim 17, wherein the fuel cell comprises a polymer electrolyte membrane.

33. A method of treating a fuel cell, comprising:
contacting a first gas comprising hydrogen gas and water to an anode of the fuel cell;
simultaneously with contacting the first gas, contacting a second gas comprising nitrogen gas and water to a cathode of the fuel cell, wherein the second gas is contacted to the cathode at a higher pressure than the first gas is contacted to the anode; and
applying a potential difference between the anode and the cathode, the cathode being negative relative to the anode.
